(19) United States
(12) Patent Application Publication
(10) Pub. No.: US 2008/0249827 A1
(43) Pub. Date: Oct. 9, 2008

(54) System to Enable Dynamic Hubs for Improving Supply-Chain Resource Management

(75) Inventor: YILDIRAY SAGER, SOMERVILLE, MA (US)

Correspondence Address: YILDIRAY SAGER, 12 STANFORD TERRACE, FL.2, SOMERVILLE, MA, 02143, US

(73) Assignee: YILDIRAY SAGER, SOMERVILLE, MA (US)

(21) Appl. No.: 12/118,816

(22) Filed: May 12, 2008

Related U.S. Application Data
(60) Provisional application No. 60/917,659, filed on May 13, 2007.

(51) Int. Cl. G06Q 10/00; G01C 21/00; B60J 11/08; B60R 27/00

(52) U.S. Cl. 705/8; 705/7; 701/300; 296/193.05

(57) ABSTRACT

This invention describes a dynamic hub system in which a transportation hub is dynamically formed by tractors that carry special design trailers. The location coordinates of the hub are conveyed a-priori to individual tractors that are going to participate in hub formation. Once the subject tractors arrive at the hub coordinates, they park and align themselves according to a pre-specified orientation and order. This information is transmitted to each truck from the control center via a wireless communication system such as GPRS. The novel electro-mechanic design of trailers allows trucks to form a portable hub, when get together. Dynamic hub system spares carriers from high cost of fixed hubs, and increases operational efficiency by lowering asset consolidation and redistribution times.

### FIELD OF THE INVENTION

This invention relates to supply-chain management systems in general, and to dynamic hub formation via trailers carried on mobile vehicles.

### BACKGROUND OF THE INVENTION

In conventional supply-chain management systems, distribution centers (also known as hubs) are used to lower delivery time and cost. To exemplify the benefit of using hubs for higher cost efficiency, consider FIG. 1 and FIG. 2. As illustrated in FIG. 1, both source A 100 and source B 130 are required to deliver their goods to destinations C 110 and D 120. The distance 105 between A 100 and C 110 is X km, the distance 115 between B 130 and D 120 is X km, and also the distance between C 110 and D 120 is X km. In this topology, the optimum route for source A 100 comprises 105 and 125. In other words, A 100 traverses 2X km. Similarly, B also traverses 2X km going over a route that comprises 115 and 135. Therefore, the total travel time for A and B in FIG. 1 is 4X km.

In FIG. 2, a transportation hub 240 is illustrated. Assume the hub 240 resides at the geometric center of the topology formed by sources A 200, B 230 and destinations C 210 and D 220. The original route for A 200 is AC 205 and CD 255. The original route for B 230 is BD 206 and DC 255. In the existence of a hub 240, sources A 200 and B 230 first meet at the hub H 240. The purpose is to collect all the goods and assets (carried by A and B) for destination C 210 at source A 200; and to collect all the goods and assets for destination D 220 at the source B 230. After these sorting and reorganization tasks are completed, A 200 does not have to travel to destination D 220, but to only destination C 210. Similarly, source B 230 needs only to travel to destination D 220. Thus, the total traveled distance becomes the sum of AH 225, HC 245, BH 215 and HD 235. In FIGS. 1 and 2, introduction of a hub decreases the total traveled distance by 42%.

In today's world, companies (e.g., FedEx, UPS, etc) are aware of the huge cost efficiency of hubs. Therefore, they build hubs to lower delivery time and minimize delivery cost. For instance, FedEx has a hub for ground transportation in Woodbridge, N.J.

### SUMMARY OF THE INVENTION

Location of a stationary hub would not be optimum if the source and destination were at different coordinates from what the hub is originally built for. Optimality is in a sense that the total distance traversed by one or more sources towards their destinations is minimized.

Once a hub is built, it is impossible to relocate the hub. In this invention, trailers are designed with special mechanisms to make them capable of forming portable hubs, when more than one specially designed trailers get together.

### BRIEF DESCRIPTION OF THE DRAWINGS

FIG. 1 illustrates delivery to multiple destinations without using a hub

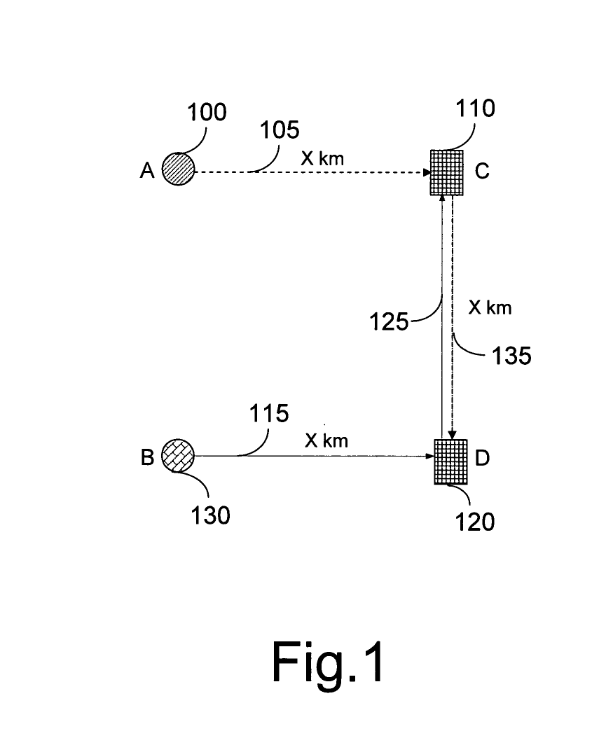

FIG. 2 illustrates how using a hub lowers the total distance traversed by multiple destinations.

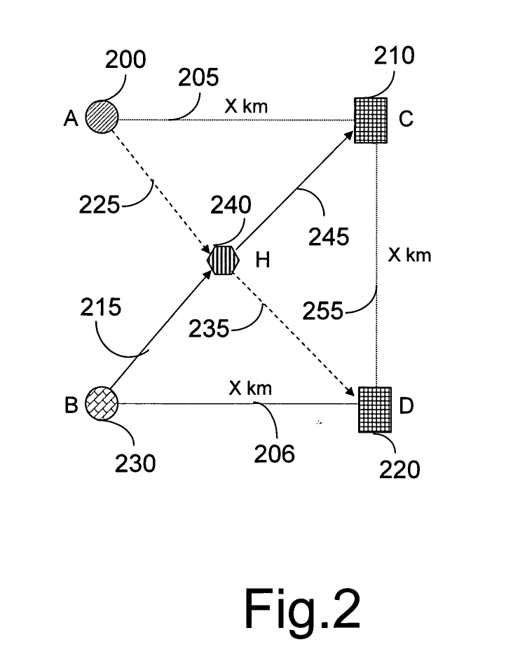

FIG. 3 illustrates key components and functionalities of a HubCon (Hub capable trailers) 300 from its left side view.

FIG. 4 illustrates key components and functionalities of a HubCon 300 from its rear and right side views.

FIG. 5 illustrates load manager 500 and side curtain 510 of the HubCon 300

FIG. 6 shows alignment mechanism for multiple trucks to form a dynamic hub according to the invention

FIG. 7 illustrates how middle and upper side panels of a truck lift-up and lower panel falls down to help dynamic hub formation

FIG. 8 illustrates the use of rear panels according to the invention

FIG. 9 illustrates how a sliding ladder is embedded in the HubCon according to the invention

FIG. 10 shows use of a curtain mechanism in the HubCon

FIG. 11 illustrates use of the adjustable side bridges according to the invention

FIG. 12 illustrates an insulation mechanism with air cushions embedded on the upper side panels in the HubCon according to the invention

FIG. 13 illustrates a dynamic hub formed with 10 trucks

### DETAILED DESCRIPTION OF THE PREFERRED EMBODIMENT

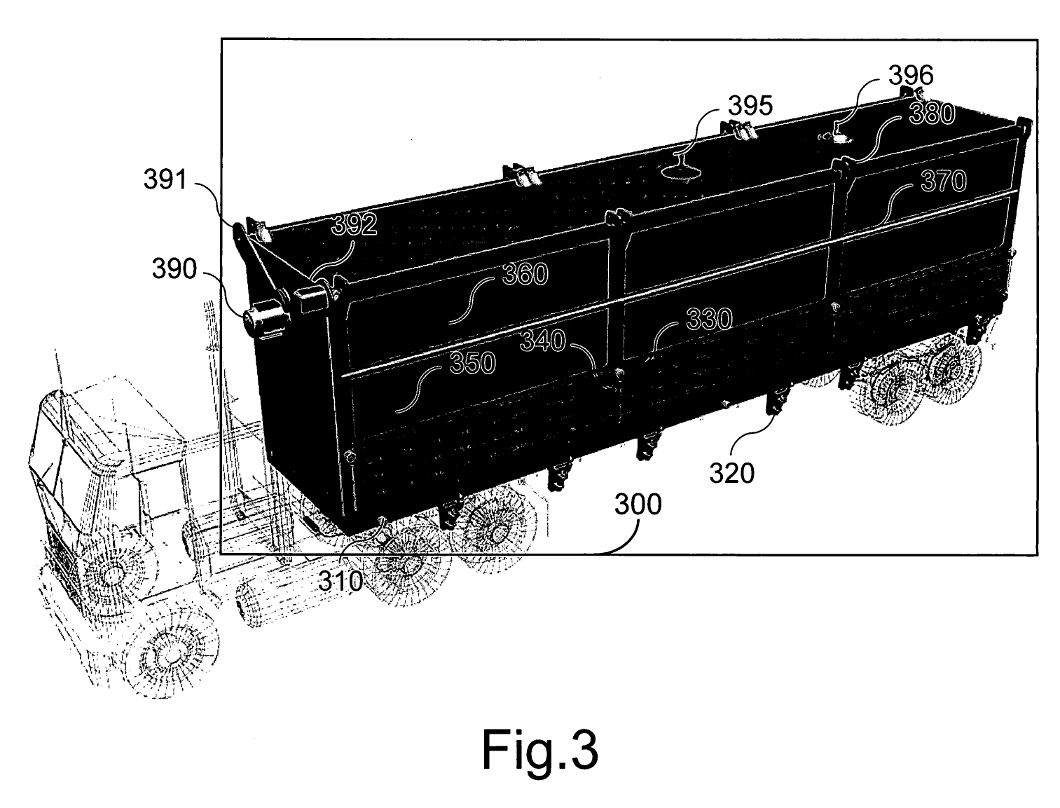

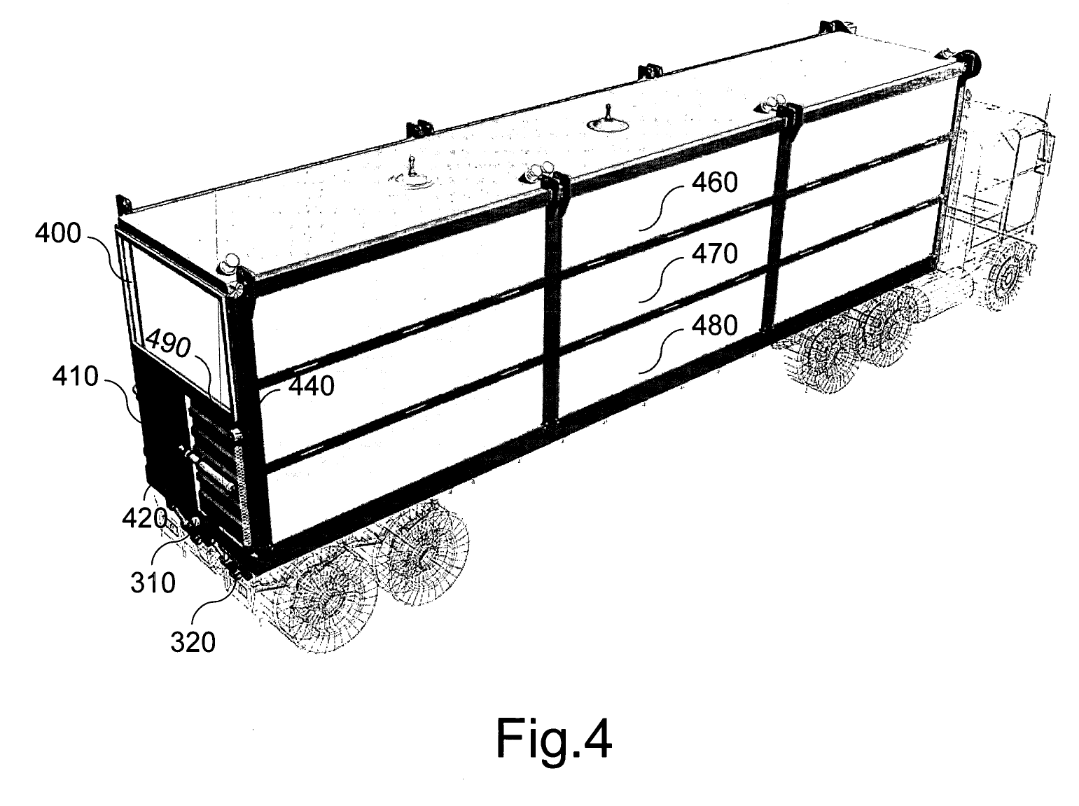

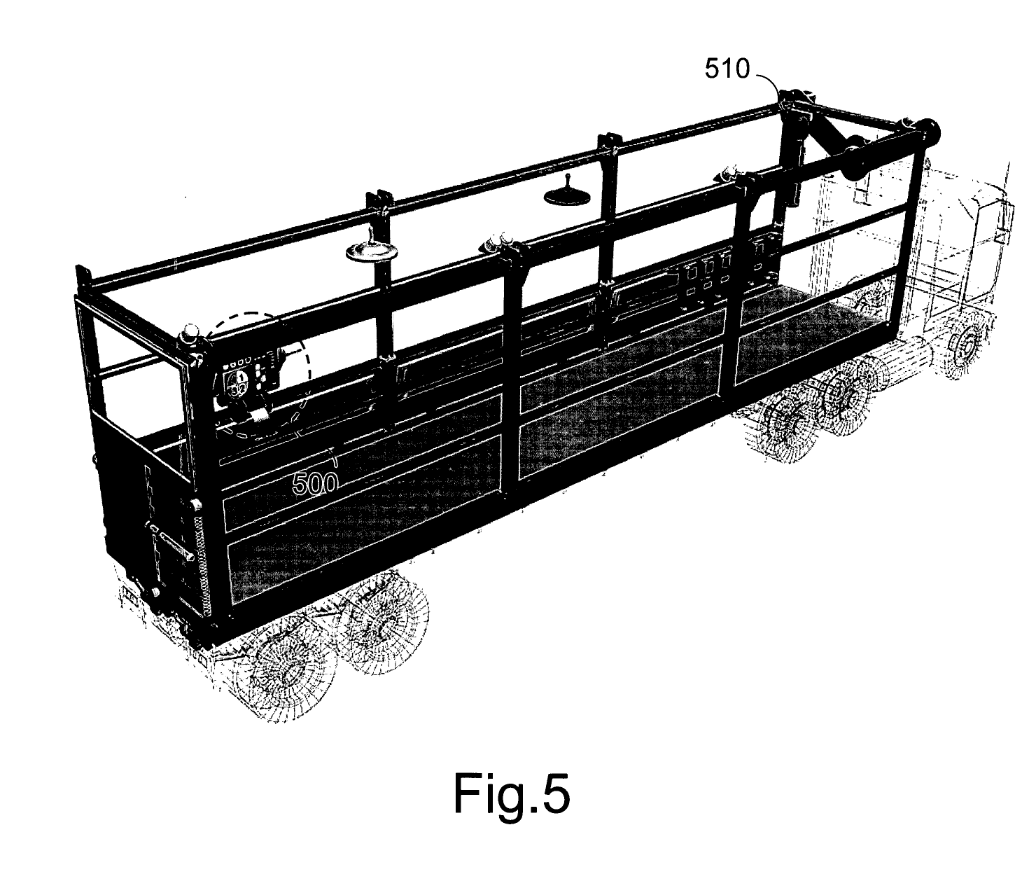

According to the current invention, trailers 300 are designed in a particular way such that a portable hub can be easily formed via multiple of them. In this embodiment, we call these hub-capable trailers HubCon. In FIG. 3, FIG. 4 and FIG. 5, key components of a HubCon 300 are illustrated. It consists of a left side upper panel 360, left side middle panel 350, left side lower panel 330, waterproof and whether proof air cushion 370, hinges 380, mechanical neighbor truck alignment apparatus 340, range sensors 310, power transmission chain 391, air compressor 392, electric motor to open the upper panel 390, wireless data communication unit antenna 396, a GPS unit 395, and a hydraulic piston to move the lower panel 320, right side upper panel 460, right side middle panel 470, right side lower panel 480, rear lower panel 440, rear middle panel 490, rear upper panel 400, rear lower panel bridge 410, hydraulic piston to move the rear lower panel bridge 420, load manager 500 and side curtain 510.

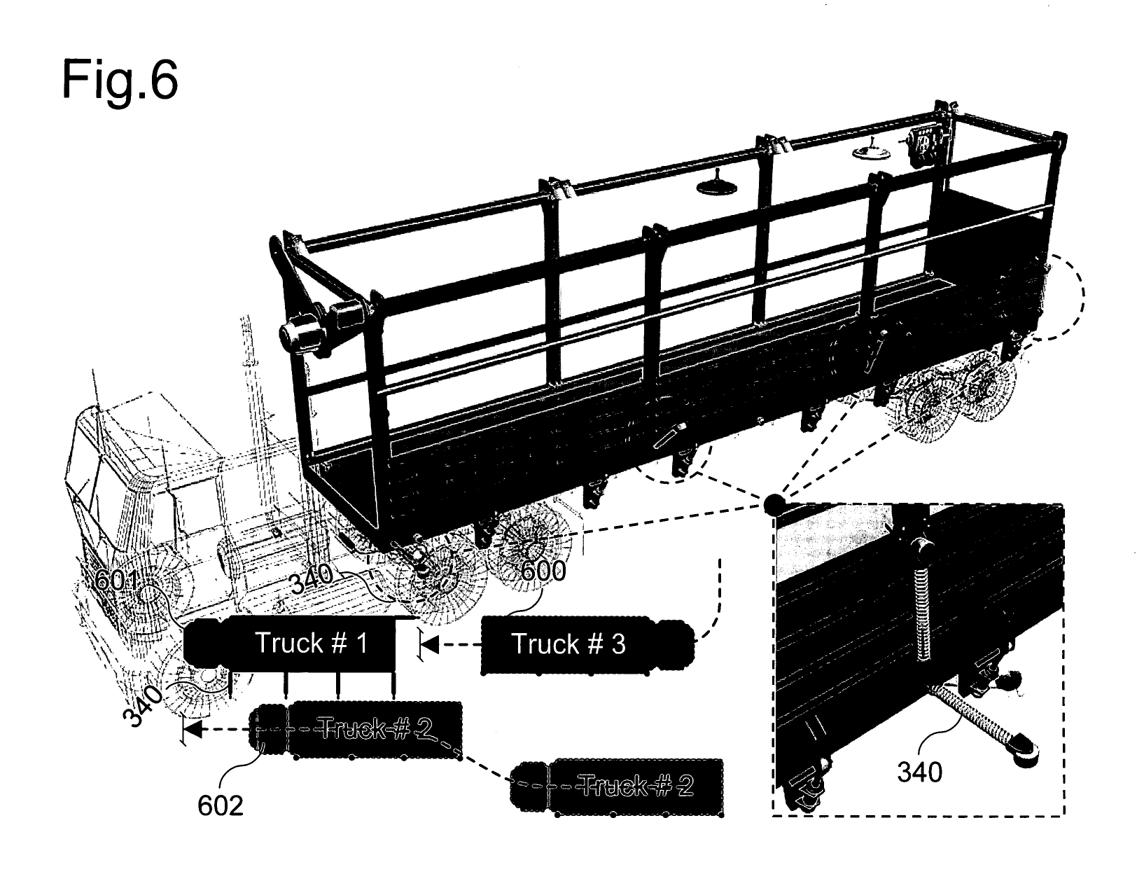

FIG. 6 shows the functionality of the truck alignment apparatus (TAA) 340. Assume that truck-1 601 is already parked and also that truck-2 602 and truck-3 600 are to park very close to truck-1 601 on the left side and in the rear respectively. The TAAs 340 of truck-1 601 open up outward in the rear for truck-3 600 and on the left side for truck-2 602. The TAAs provide a feedback to truck-2 602 and truck-3 600 to ease their parking next to truck-1 601. Orientations of the trucks must be side-to-side (e.g., truck-1 601 and truck-2 602 in FIG. 6) or rear-to-rear (e.g., truck-1 601 and truck-3 600 as in FIG. 6). This is necessary to be able to form a dynamic hub with more than one trailer 300.

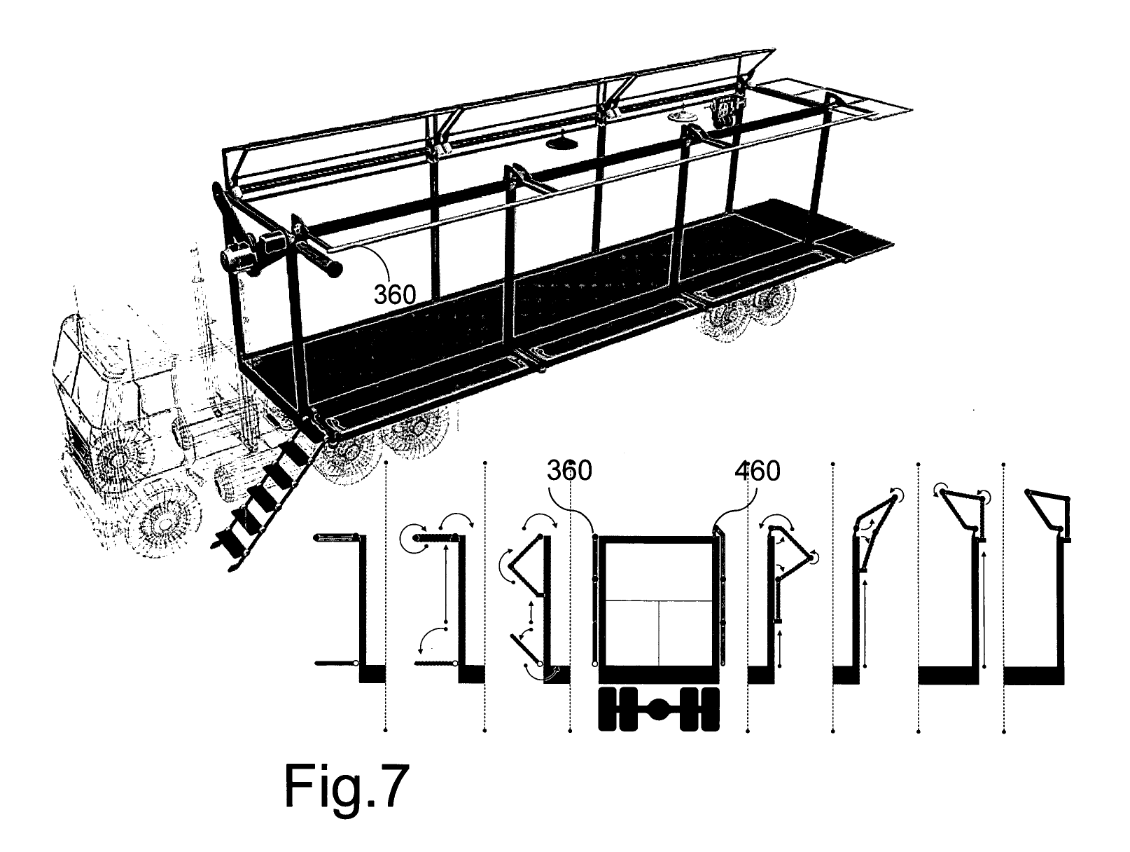

FIG. 7 shows how the left-side upper panel 360 is lifted to let the two trucks park next to each other. After being lifted, it 360 makes a right angle with the body of its trailer 300. The right-side upper panel 460 does not have this requirement. However, the right side upper panel 460 lifts higher than the left side upper panel 360. By this asymmetric lifting, the right side of truck-2 602 can easily merge with the left side of truck-1 601.

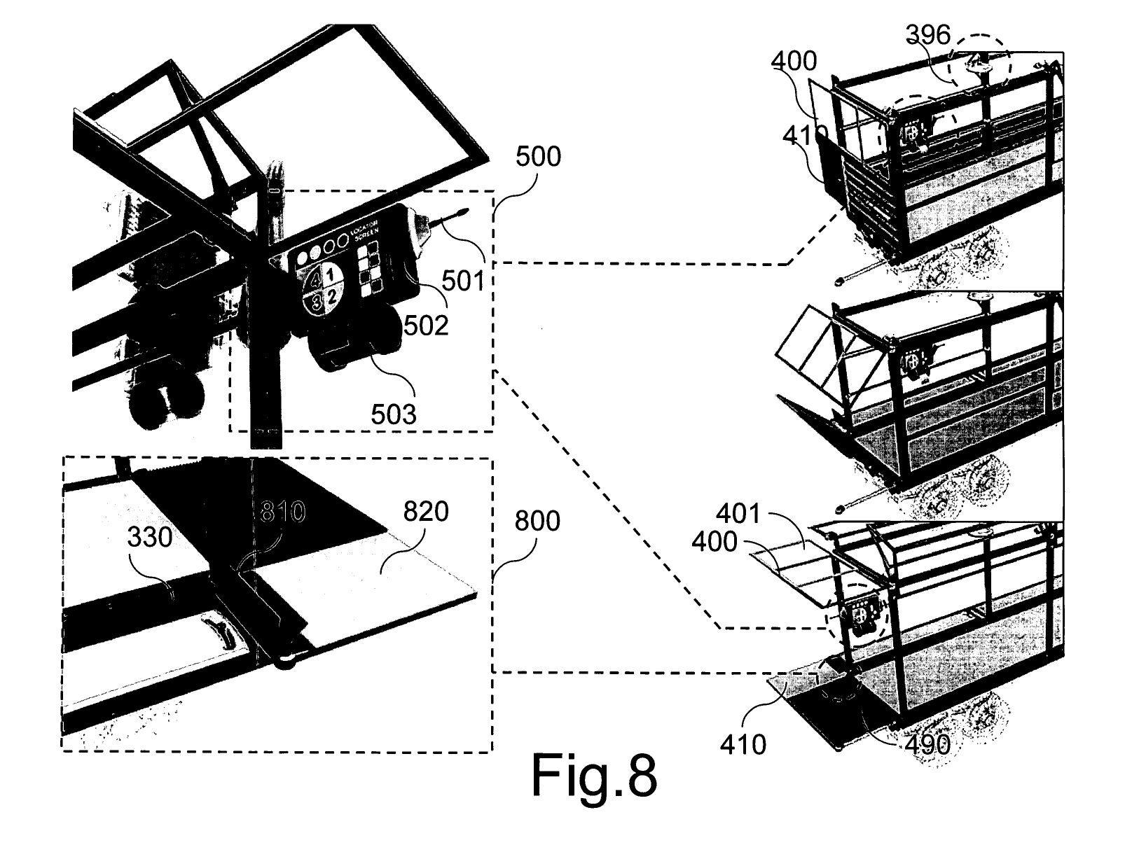

As illustrated in FIG. 8, the rear upper panel 400 of truck-1 601 also lifts up by a quarter-circle movement for merging of truck-1 601 and truck-3 600 back-to-back. The upper panel bridge 401 of truck-1 601, after its rear-upper panel 400 is lifted, slides towards the left to cover the gap between the left-side upper panel 360 and the rear-side upper panel 400. The rear lower panel 490 also opens outward and the rear lower panel bridge 410 slides to the right to function as a corner bridge 820. The corner bridge 820 covers the gap between the left side lower panel 330 and the rear lower panel 490. The patch 810 covers the gaps between the left-side lower panel and the corner bridge 820 as shown the block 800 in FIG. 8. Each trailer is also equipped with a load manager 500. Load manager has a display 502, printer 503 and a radio communication unit 501. It establishes communication between multiple trailers, and manages formation of the dynamic hub by determining orientation and position of each trailer 300 and identifying the loads to be exchanged from a trailer 300 to one another.

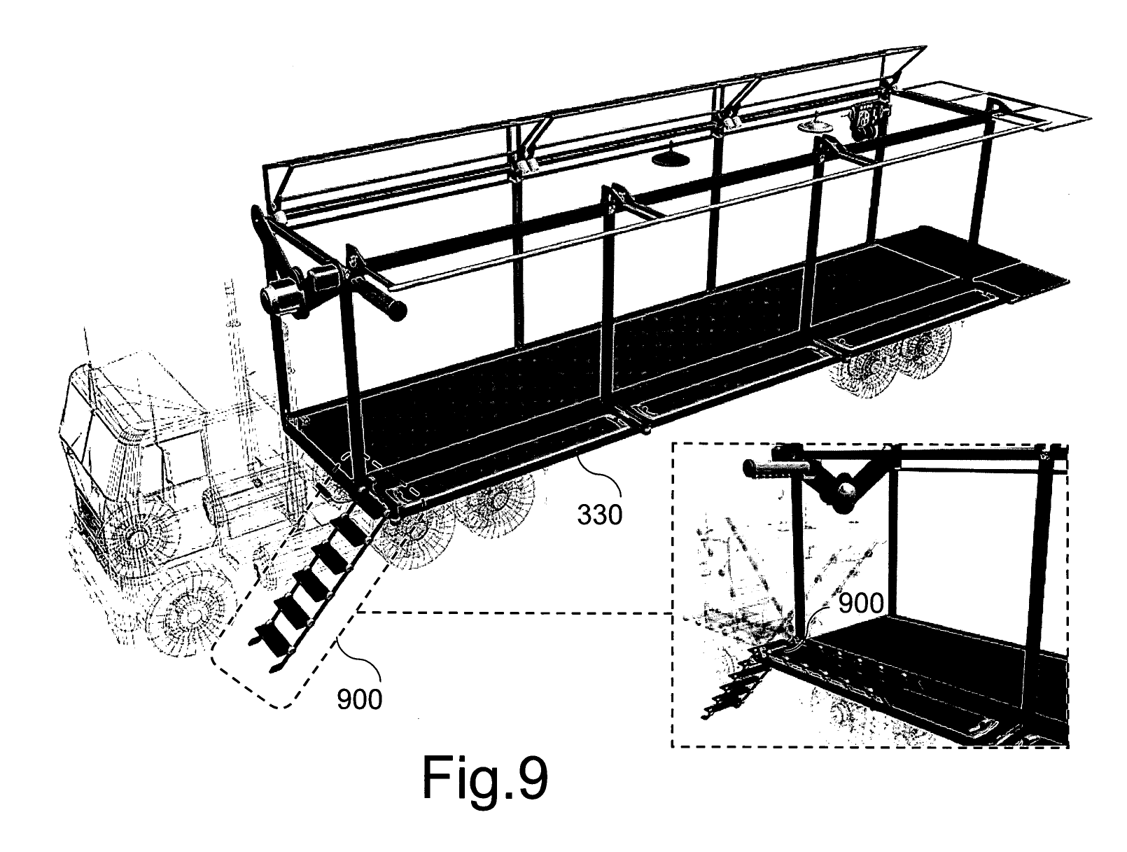

Once the left side lower panel 330 is dropped out as shown in FIG. 9, a ladder 900 slides out to help workers easily get on and off the trailer 300.

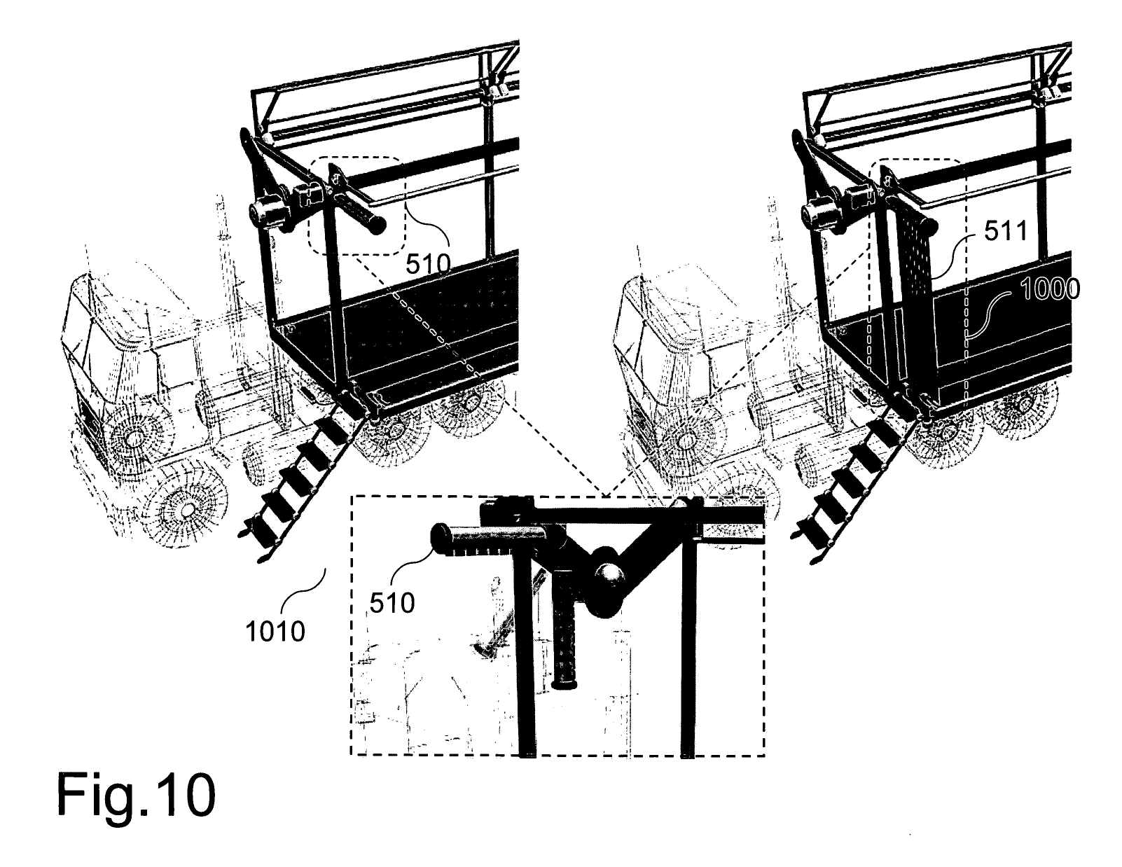

As shown in FIG. 10, there is also a rod 510 that contains a side curtain 511 inside. The rod 510 rotates out and drops its curtain 511 (depicted in 1010 of FIG. 10) to provide a shielded entry into the trailer 300 (see 1000 in FIG. 10).

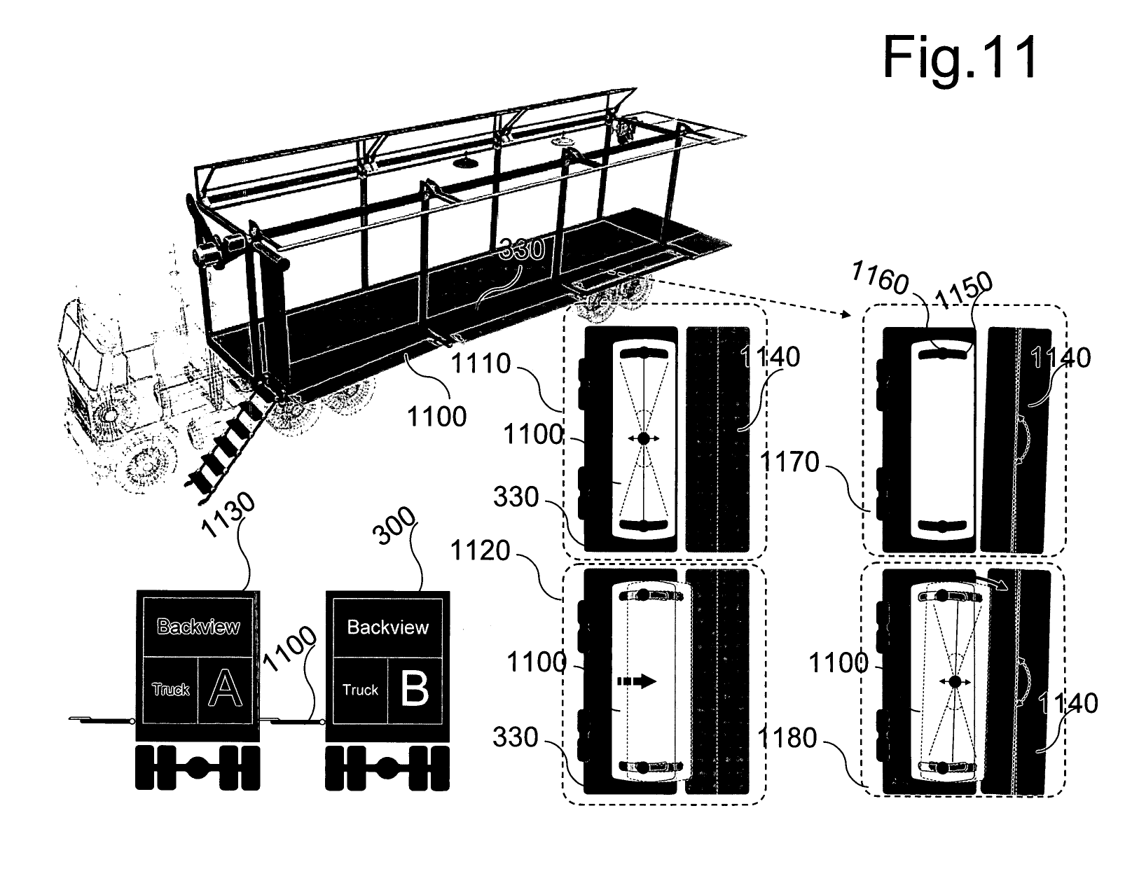

As shown in FIG. 11, attached to the inner part of each left side lower panel 330 is an adjustable side bridge 1100. When two trucks 1130 and 300 don't have a perfect side-by-side alignment during the merging of their trailers 300, these side bridges 1100 are used to close the gaps (see 1110 and 1120) and/or to provide a smooth surface (see 1170 and 1180). The side bridges 1110 can move straight outward as much as needed and they can also rotate and move out to cover up misalignment errors between lower panels 330 and 1140 of trailers 300 and 1130 respectively. Special shape moldings 1150 allow these lower side bridges to inward and outward easily.

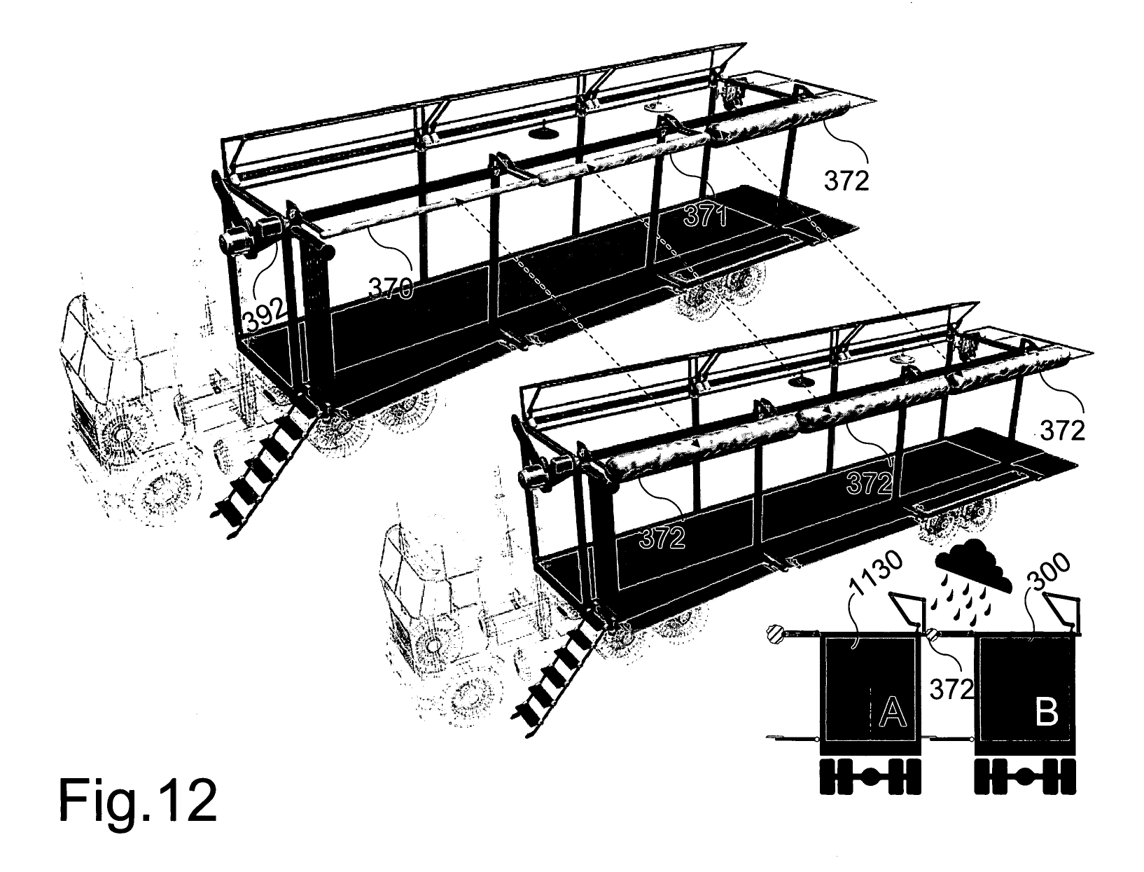

FIG. 12 illustrates that waterproof and weatherproof air cushion 370 is inflated to close the gaps between merged trailers and to provide insulation. The compressor 392 is used to pump air into the air cushion 370. When partially filled with air, the air cushion 370 expands 371. When it 370 is fully filled with air, it 372 completely closes the gaps between the two trailers 1130 and 300.

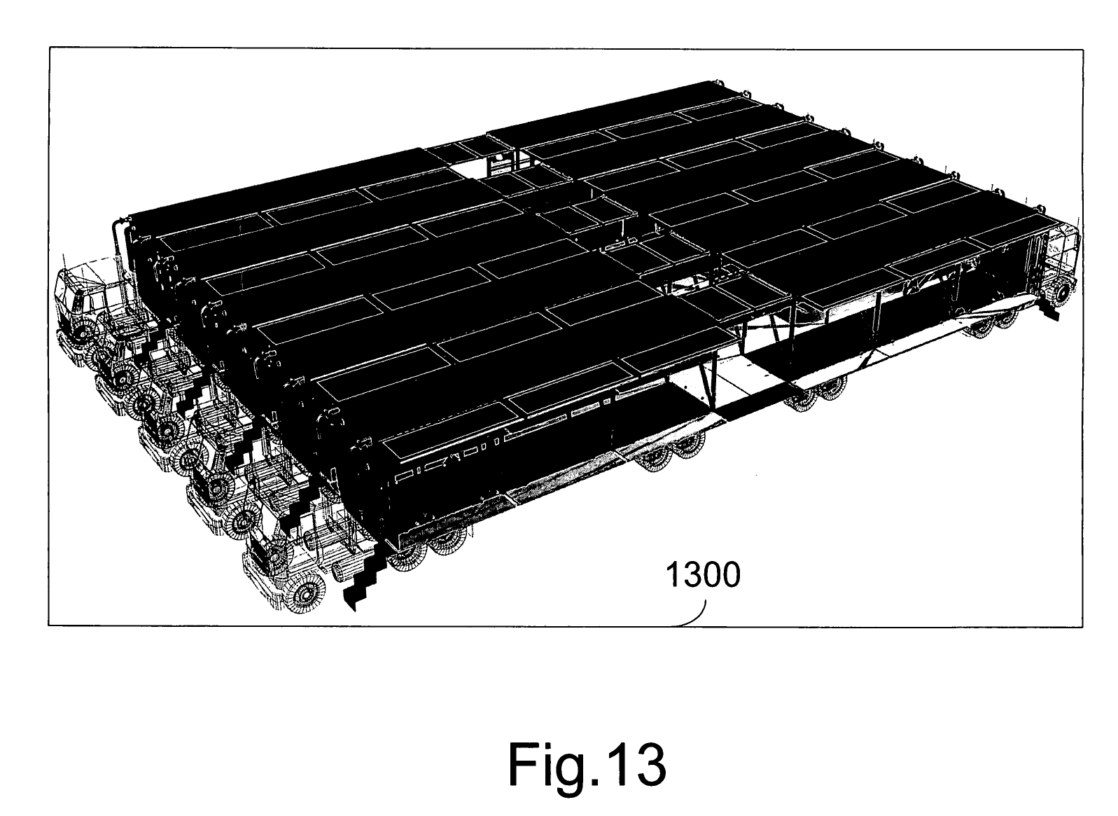

FIG. 13 illustrates 10 merged trailers. Five trucks get together side-by-side and they are back-to-back with the other five. In this invention, the words ‘left’ and ‘right’ used for illustrative purposes. Functionalities attributed to the components on the left and right sides of a trailer can be switched.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

What is claimed is:

1. A system to enable dynamic hub formation for improving supply-chain resource management efficiency, comprising
an operation planning center to collect and process cargo shippers' and receivers' profiles to compute optimum dynamic hub related information
a tractor with a special design trailer,
wherein the said special design trailer further comprises a left side upper panel, left side middle panel, left side lower panel, waterproof and weather proof air cushion, hinges, mechanical neighbor truck alignment apparatus, range sensors, power transmission chain, air compressor, electric motor to open the upper panel, wireless data communication unit antenna, a GPS unit, and a hydraulic piston to move the lower panel, right side upper panel, right side middle panel, right side lower panel, rear lower panel, rear middle panel, rear upper panel, rear lower panel bridge, hydraulic piston to move the rear lower panel bridge, load manager and side curtain.

2. The system of claim 1, wherein the said dynamic hub related information comprises the location coordinates of the dynamic hub, identities of the trailers that are responsible for forming the said dynamic hub, and positions of the said trailers in the said dynamic hub with respect to one another to expedite asset consolidation and redistribution.

3. The system of claim 1, wherein the said operation-planning center communicates with the said tractors wirelessly to convey the said dynamic hub related information.

4. The system of claim 1, wherein the said cargo shippers' and receivers' profile comprises location coordinates of the shippers and receivers.

5. The system of claim 1, wherein the said mechanical neighbor truck alignment apparatus is placed at least on one of the left side of the said truck, the right rear side of the said truck and the rear side of the said truck.

6. The system of claim 1, wherein the said mechanical neighbor truck alignment apparatus open up outward to help the said truck park tightly with another said truck. to form the said dynamic hub.

7. The system of claim 1, wherein orientations of the said trucks are side-to-side or rear-to-rear to be able to form the said dynamic hub.

8. The system of claim 1, wherein the said special design trailer is equipped with a load manager unit.

9. The system of claim 8, the said load manager unit comprises a display, printer and a radio communication unit.

10. The system of claim 9, the said display displays one or more of the orientation of the said truck in claim 1, the said truck's position relative to the other trucks in the said dynamic hub in claim 1, and the identification information of the assets to be exchanged between the said trailer in claim 1 and other trailers in the said dynamic hub in claim 1.
